(19) United States
(12) Patent Application Publication
(10) Pub. No.: US 2018/0283378 A1
(43) Pub. Date: Oct. 4, 2018

(54) HYDROGEN CIRCULATION PUMP FOR FUEL CELL

(71) Applicant: KABUSHIKI KAISHA TOYOTA JIDOSHOKKI, Aichi (JP)

(72) Inventors: Takayuki HIRANO, Aichi-ken (JP); Daisuke MASAKI, Aichi-ken (JP); Tatsuyuki HOSHINO, Aichi-ken (JP); Shintaro KASHIWA, Aichi-ken (JP); Naoki TAKANI, Aichi-ken (JP)

(73) Assignee: KABUSHIKI KAISHA TOYOTA JIDOSHOKKI, Aichi (JP)

(21) Appl. No.: 15/935,340

(22) Filed: Mar. 26, 2018

(30) Foreign Application Priority Data
Mar. 29, 2017 (JP) 2017-064867

(51) Int. Cl. F04C 18/12; H01M 8/04082

(52) U.S. Cl. CPC F04C 18/126; F04C 2210/224; F04C 2240/20; H01M 8/04201

(57) ABSTRACT

A hydrogen circulation pump for a fuel cell includes a housing, rotary shafts, and two-lobe rotors. Each of the rotors has a configuration defined by the profile defined by an arc having a radius R and extending from apex end to a first transition point, an involute curve extending from the first transition point to a second transition point, and an envelope curve formed continuously with the involute curve from the second transition point to the bottom end based on a basic circle having a radius r′. A distance between the apex ends of the lobe portions of each of the rotors is D. A distance between the axes of the pair of the rotary shafts is L. The radius R is set in {(√2)/16}πL<R<{(27−5√2)/56}L, and the radius r is set in L/(2√2)<r<0.3(√2)L, and the radius r′ is set in π/(4√2)L<r′<1.28π/(4√2)L, and the distance D is set in 2{L+π/(4√2)L}<D<2.032{L+π/(4√2)L}.

### BACKGROUND OF THE INVENTION

The present invention relates to a hydrogen circulation pump for a fuel cell.

Japanese Patent No. 4613811 discloses a roots type fluid machine including a housing having a rotor chamber, a pair of rotary shafts that is rotatably arranged in parallel to each other in the rotor chamber, and two-lobe type rotors fixedly mounted on the respective rotary shafts in the rotor chamber. Each of the rotors has two lobe portions and two well portions so that one of the lobe portions of one of the rotors engages with one of the well portions of the other rotor.

Each of the rotors has a configuration defined by a profile that extends from each apex end of the lobe portions to bottom ends of the well portions along a circumferential direction of the rotor and an outer surface of the rotor that is generated by extending the profile of the rotor in the axial direction of the rotary shaft on which the rotor is fixedly mounted. Specifically, the profile of the rotor is defined by an arc having a radius R from the apex end to the first transition point, an involute curve formed continuously with the arc and extending from the first transition point to the second transition point based on a basic circle having a radius r around the axis of the rotary shaft, and an envelope curve formed continuously with the involute curve from the second transition point to the bottom end based on a basic circle having a radius R around the axis. The paired rotary shafts are spaced away from each other. The radiuses R and r are set in respective ranges where the distance L between the axes of the paired rotary shafts is set in a range.

The above fluid machine may inhibit progression of a trouble caused by interference between the rotors due to phase shift while securing large fluid volume.

In the above fluid machine, the envelope curve of the arc having a radius R is formed between the second transition point and the bottom end and, therefore, space is not formed between the lobe portion of one rotor and the well portion of the other rotor, so that noise hardly occurs when gas is released from the compression state. Even if space is not formed between the lobe portion and the well portion, however, in the case that liquid such as water generated in a fuel cell is trapped between the lobe portion and the well portion, water-biting noise may occur due to liquid compression. In the above fluid machine, the profile of the rotor is designed without considering such water-biting noise. If the clearance between the paired rotors is increased to avoid the water-biting noise caused by liquid such as water trapped between the lobe portion and the well portion, the fluid machine may also have a problem in that the volume efficiency decreases.

The present invention which has been made in light of the above problems is directed to providing a hydrogen circulation pump for a fuel cell to have high volume efficiency without water-biting noise caused by liquid such as water trapped between a lobe portion and a well portion of rotors.

### SUMMARY OF THE INVENTION

In accordance with an aspect of the present invention, there is provided a hydrogen circulation pump for a fuel cell, including a housing having a rotor chamber, a pair of rotary shafts rotatably arranged in parallel to each other in the rotor chamber, and a two-lobe rotor fixedly mounted on each of the rotary shafts in the rotor chamber, each of the rotors having two lobe portions and two well portions so that one of the lobe portions of one of the rotors engages with one of the well portions of the other rotor. Each of the rotors has a configuration defined by a profile that extends from each apex end of the lobe portions to bottom ends of the well portions along a circumferential direction of the rotor and an outer surface that is generated by extending the profile in an axial direction of the rotary shaft of the rotor. The profile is defined by an arc having a radius R and extending from the apex end to a first transition point, an involute curve formed continuously with the arc and extending from the first transition point to a second transition point based on a basic circle having a radius r around an axis of the rotary shaft, and an envelope curve formed continuously with the involute curve from the second transition point to the bottom end based on a basic circle having a radius r′ around the axis. A distance between the apex end of one of the lobe portions and the apex end of the other of the lobe portions of each of the rotors is D. A distance between the axes of the pair of the rotary shafts is L. The radius R is set in a range {(√2)/16}πL<R<{(27−5√2)/56}L, and the radius r is set in a range L/(2√2)<r<0.3(√2)L, and the radius r′ is set in a range π/(4√2)L<r′<1.28π/(4√2)L, and the distance D is set in a range 2{L+π/(4√2)L}<D<2.032{L+π/(4√2)L}.

Other aspects and advantages of the invention will become apparent from the following description, taken in conjunction with the accompanying drawings, illustrating by way of example the principles of the invention.

### BRIEF DESCRIPTION OF THE DRAWINGS

The invention together with objects and advantages thereof, may best be understood by reference to the following description of the embodiments together with the accompanying drawings in which:

FIG. 1 is a longitudinal sectional view of a hydrogen circulation pump for a fuel cell according to an embodiment of the present invention;

FIG. 2 is a plane view showing the profiles of a rotor chamber and paired rotors of the hydrogen circulation pump for a fuel cell of FIG. 1;

FIG. 3 is a graph showing the relation between the volume efficiency and the water-biting clearance of the paired rotors with respect to the basic circle radius;

FIG. 4A is a fragmentary enlarged plane view showing the paired rotors at a rotational angle in the hydrogen circulation pump for a fuel cell of FIG. 1;

FIG. 4B is a fragmentary enlarged plane view showing the paired rotors at the rotational angle advanced by 10 degrees as compared with the state shown in FIG. 4A;

FIG. 5 is a graph showing the relation between the volume efficiency and the water-biting clearance of the paired rotors with respect to D′/D;

FIG. 6A is a fragmentary enlarged plane view showing paired rotors at a rotational angle of a hydrogen circulation pump for a fuel cell for comparison; and

FIG. 6B is a fragmentary enlarged plane view showing the paired rotors at the rotational angle advanced by 10 degrees as compared with the state shown in FIG. 6A.

### DETAILED DESCRIPTION OF THE EMBODIMENTS

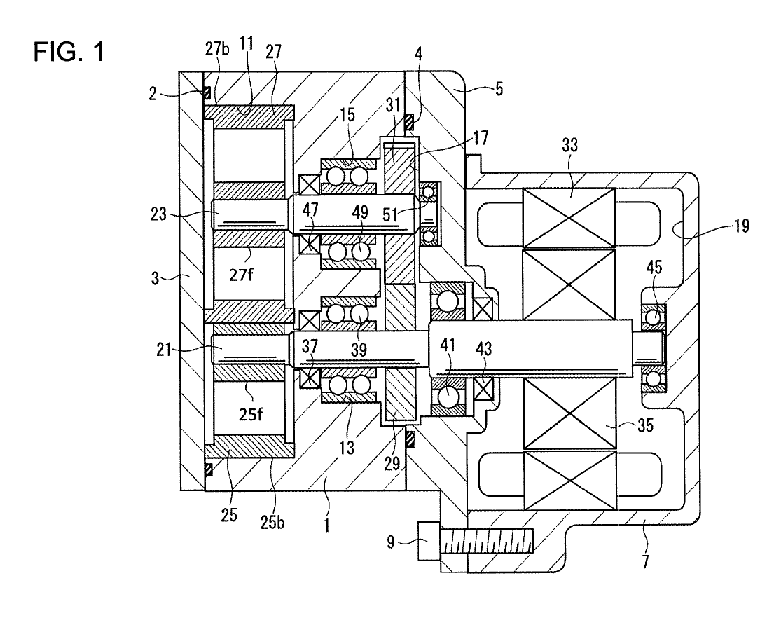

The following will describe a hydrogen circulation pump for a fuel cell according an embodiment of the present invention with reference to the accompanying drawings. Referring to FIG. 1, the hydrogen circulation pump for a fuel cell according to the present embodiment has a rotor housing 1, an end housing 3, a gear housing 5, and a motor housing 7. Bolts not shown fix the rotor housing 1, the end housing 3, and the gear housing 5. Bolts 9 (only one bolt shown) fix the gear housing 5 and the motor housing 7. An O-ring 2 is disposed between the rotor housing 1 and the end housing 3. An O-ring 4 is disposed between the rotor housing 1 and the gear housing 5. The rotor housing 1, the end housing 3, the gear housing 5, and the motor housing 7 correspond to “housing” of the present invention.

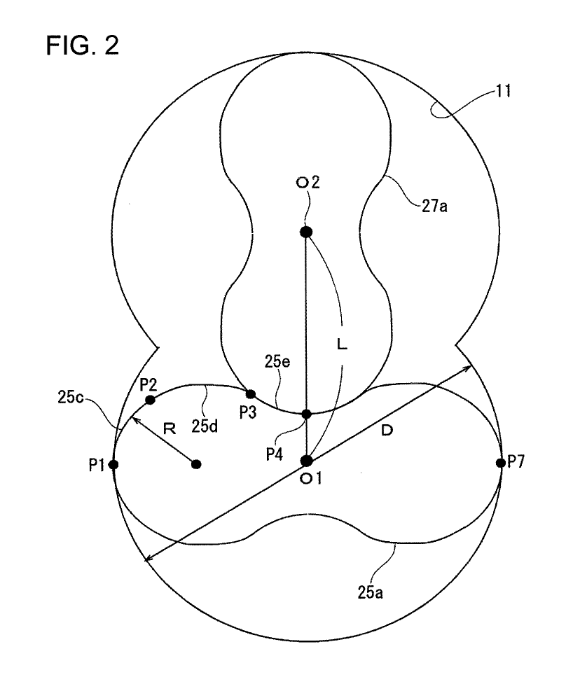

The rotor housing 1 has a rotor chamber 11. The rotor housing 1 and the gear housing 5 have a first shaft hole 13 and a second shaft hole 15. Referring to FIG. 2, the rotor chamber 11 is overlappingly formed by a cylindrical space having the first axis O1 as the center axis and a cylindrical space having the second axis O2 as the center axis. The rotor chamber 11 has a suction port and a discharge port that are not shown. The first axis O1 and the second axis O2 are arranged in parallel to each other. As shown in FIG. 1, the first shaft hole 13 extends in the direction of the first axis O1 behind the rotor chamber 11. The second shaft hole 15 extends in the direction of the second axis O2 behind the rotor chamber 11.

The rotor housing 1 and the gear housing 5 form a gear chamber 17. The gear housing 5 and the motor housing 7 form a motor chamber 19. The first shaft hole 13 extends through the gear housing 5 and communicates the rotor chamber 11, the gear chamber 17, and the motor chamber 19. The second shaft hole 15 is covered by the gear housing 5 and communicates the rotor chamber 11 and the gear chamber 17.

A first rotary shaft 21 is inserted in the first shaft hole 13. A second rotary shaft 23 is inserted in the second shaft hole 15. In the rotor chamber 11, a first rotor 25 is fixedly mounted on the first rotary shaft 21 and a second rotor 27 is fixedly mounted on the second rotary shaft 23. The first and second rotors 25 and 27 are a pair of two-lobe type and have two lobe portions and two well portions such that one of the lobe portions of one of the rotors engages with one of the well portions of the other rotor. Hollow portions 25f and 27f are formed in the lobe portions of the first and second rotors 25 and 27, respectively, to reduce weight.

In the gear chamber 17, a first gear 29 is fixedly mounted on the first rotary shaft 21 and a second gear 31 is fixedly mounted on the second rotary shaft 23. The first and second gears 29 and 31 engage with each other. In the motor chamber 19, a stator 33 is fixed to the motor housing 7 and a motor rotor 35 is fixed on the first rotary shaft 21. The stator 33 is supplied with electric power through a harness not shown.

The first shaft hole 13 extends through the rotor housing 1 and the gear housing 5. In the first shaft hole 13 formed in the rotor housing 1, a seal device 37 and a bearing device 39 are disposed on the side of the rotor chamber 11 between the rotor chamber 11 and the gear chamber 17. In the first shaft hole 13 formed in the gear housing 5, a bearing devices 41 and a seal device 43 are disposed on the side of the gear chamber 17 between the gear chamber 17 and the motor chamber 19. A bearing device 45 is disposed in the motor housing 7. The first rotary shaft 21 is supported by the bearing devices 39, 41, and 45 and is rotatable through the seal devices 37 and 43 and the bearing devices 39, 41, and 45 around the first axis O1.

The second shaft hole 15 extends through the rotor housing 1 and formed partially in the gear housing 5. In the second shaft hole 15 formed in the rotor housing 1, a seal devices 47 and a bearing device 49 are disposed on the side of the rotor chamber 11 between the rotor chamber 11 and the gear chamber 17. A bearing device 51 is disposed in the second shaft hole 15 formed in the gear housing 5. The second rotary shaft 23 is supported by the bearing devices 49 and 51 and is rotatable through the seal device 47 and the bearing devices 49 and 51 around the second axis O2.

The first and second rotors 25 and 27 are defined by profiles 25a and 27a shown in FIG. 2 and outer surfaces 25b and 27b shown in FIG. 1, which are defined by extending the profiles 25a and 27a in the directions of the first and second axes O1 and O2, respectively.

Specifically, as shown in FIG. 2, the profile 25a of the first rotor 25 is defined by an arc 25c having a radius R and extending from an apex end P1 to a first transition point P2, an involute curve 25d formed continuously with the arc 25c and extending from the first transition point P2 to a second transition point P3 based on a basic circle having a radius r around the first axis O1, and an envelope curve 25e formed continuously with the involute curve 25d from the second transition point P3 to the bottom end P4 based on a basic circle having a radius r′ around the first axis O1. The profile 25a is defined by repeatedly drawing the arc 25c, the involute curve 25d, and the envelope curve 25e in the peripheral direction of the first rotor 25. The same is true of the profile 27a of the second rotor 27.

Reference symbol D indicates the distance from the apex end P1 to an apex end P7 of the first rotor 25. When assuming a conventional roots type pump having involute type rotors, the first and second rotors having an involute curve are defined by the arc having a radius R and extending from the apex end P1 to the first transition point P2, the involute curve extending from the first transition point P2 to the second transition point P3 based on a basic circle having a radius r, and the arc having a radius r′ and extending from the second transition point P3 to the bottom end P4.

Reference symbol L indicates the distance between the first and second axes O1 and O2. In the conventional first and second rotors, the radius R is indicated by an expression R=π/(4√2)L. The radius r is indicated by an expression r=L/(√2). The distance D is indicated by an expression D=2{L+π/(4√2)L}.

That is, in the first and second rotors having an involute curve of the conventional roots type pump, the design parameter only depends on the distance L. The distance D can be calculated by the distance L. The theoretical discharge volume Vth is determined by an expression Vth=0.8545D²L per one rotation with respect to the first and second rotary shafts 21 and 23.

When a distance that is larger than the distance D, which is determined by the expression D=2{L+π/(4√2)L}, is assumed and given a reference symbol D′, the radius r′ is designable by a range R<r′<1.28R.

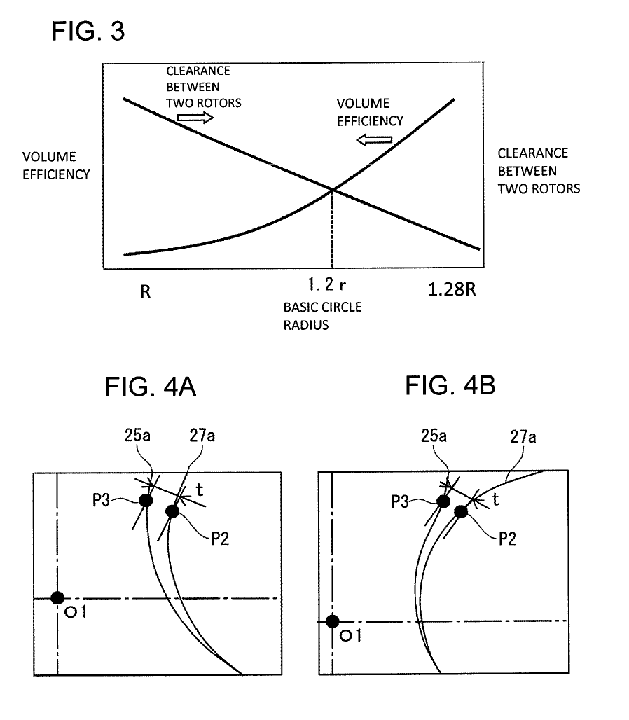

As shown in FIG. 3, when the radius r′ of the basic circle is increased from the radius R to the radius 1.28R, a clearance t between the second transition point P3 of one of the rotors and the first transition point P2 of the other of the rotors becomes very small as shown in FIGS. 6A and 6B. Thus, water-biting noise may occur due to liquid compression in that liquid such as water generated by a fuel cell and trapped in the clearance t is compressed.

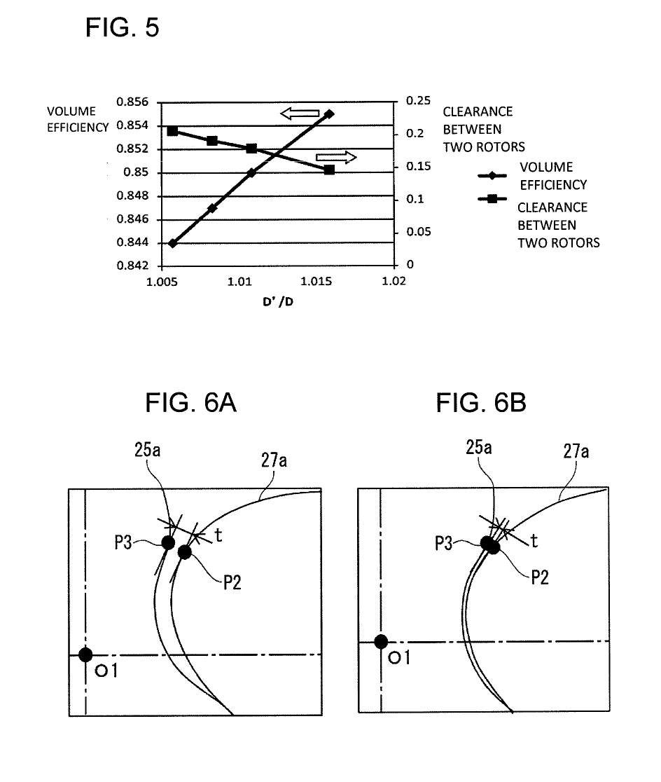

For this reason, the value determined by an expression r=1.2R is an optimum value of the radius r′. In this case, as shown in FIG. 4, the clearance t is securely provided. As shown in FIG. 5, when the clearance t is 0.14 mm or more, experiments show noise can be effectively suppressed. The condition that the clearance t is 0.14 mm or more is satisfied when the distance D′ is in a range D<D′<1.016D.

Considering the expression D=2{L+π/(4√2)L}, the distance D′ is set in the following range:

2{L+π/(4√2)L}<D′<2.032{L+π/(4√2)L}.

Then, the theoretical discharge volume Vth is determined by an expression Vth=0.855D²L and substantially the same as in the first and second rotors having an involute curve of the conventional roots type pump.

In the hydrogen circulation pump for a fuel cell according to the present invention, when setting the respective ranges of the distance L between the first and second rotary shafts 21 and 23, the radius R, and the radius r, the expressions for the roots type fluid machine disclosed in Japanese Patent No. 4613811 are applied.

That is, the radius r is set in a range L/(2√2)<r<0.3(√2)L.

Also, the radius R is set in a range {(√2)/16}πL<R<{(27−5√2)/56}L.

Therefore, progression of a trouble caused by interference between the first and second rotors 25 and 27 due to phase shift can be prevented while securing large volume for hydrogen including liquid such as water generated by a fuel cell. In the hydrogen circulation pump for a fuel cell according to the present invention, the clearance t is hardly enlarged and, therefore, no water-biting noise occurs due to liquid compression in that liquid such as water generated by a fuel cell and trapped in the clearance t is compressed.

In the hydrogen circulation pump for a fuel cell according to the present invention, the arc from the second transition point P3 to the bottom end P4 is formed by the envelope curve based on a basic circle having the radius r′. The distance D is a distance from the apex end P1 to the apex end P7 in the first and second rotors 25 and 27. The radius r′ and the distance D are set in respective predetermined ranges and, therefore, appropriate clearance t can be secured. As a result, the hydrogen circulation pump for a fuel cell according to the present invention can have high volume efficiency.

The present invention is not limited to the above-described embodiment, but it may be modified in various ways.

The present invention may be applied to a fuel cell powered automobile.

What is claimed is:

1. A hydrogen circulation pump for a fuel cell, comprising:
a housing having a rotor chamber;
a pair of rotary shafts rotatably arranged in parallel to each other in the rotor chamber; and
a two-lobe rotor fixedly mounted on each of the rotary shafts in the rotor chamber, each of the rotors having two lobe portions and two well portions so that one of the lobe portions of one of the rotors engages with one of the well portions of the other rotor,
wherein each of the rotors has a configuration defined by a profile that extends from each apex end of the lobe portions to bottom ends of the well portions along a circumferential direction of the rotor and an outer surface that is generated by extending the profile in an axial direction of the rotary shaft of the rotor,
wherein the profile is defined by an arc having a radius R and extending from the apex end to a first transition point, an involute curve formed continuously with the arc and extending from the first transition point to a second transition point based on a basic circle having a radius r around an axis of the rotary shaft, and an envelope curve formed continuously with the involute curve from the second transition point to the bottom end based on a basic circle having a radius r′ around the axis, wherein a distance between the apex end of one of the lobe portions and the apex end of the other of the lobe portions of each of the rotors is D, wherein a distance between the axes of the pair of the rotary shafts is L, and wherein the radius R is set in a range {(√2)/16}πL<R<{(27−5√2)/56}L, and the radius r is set in a range L/(2√2)<r<0.3(√2)L, and the radius r′ is set in a range π/(4√2)L<r′<1.28π/(4√2)L, and the distance D is set in a range 2{L+π/(4√2)L}<D<2.032{L+π/(4√2)L}.
